(19) United States
(12) Patent Application Publication
(10) Pub. No.: US 2008/0174606 A1
(43) Pub. Date: Jul. 24, 2008

(54) METHOD AND APPARATUS FOR LOW POWER REFRESH OF A DISPLAY DEVICE

(76) Inventors: Srikanth Rengarajan, Austin, TX (US); Mark N. Fullerton, Austin, TX (US); Arthur R. Miller, Austin, TX (US); Joseph K. Fox, Austin, TX (US)

Correspondence Address: KENYON & KENYON LLP, 333 W. SAN CARLOS STREET, SUITE 600, SAN JOSE, CA, 95110-2731, US

(21) Appl. No.: 12/017,777

(22) Filed: Jan. 22, 2008

Related U.S. Application Data
(60) Provisional application No. 60/886,214, filed on Jan. 23, 2007.

(51) Int. Cl. G09G 5/39; G09G 5/36

(52) U.S. Cl. 345/531; 345/556

(57) ABSTRACT

A method and system for rendering a frame to be displayed on a screen includes a memory-sink mechanism configured to store a copy of a screen image in memory, a snoop mechanism configured to monitor a system parameter, a controller configured to switch between first and second operation modes in response to the snoop mechanism detecting a change to the system parameter, and a rendering mechanism to retrieve the copy of the screen image when the system operates in the second mode of operation.

### REFERENCE TO RELATED APPLICATION

The present application claims the benefit of co-pending U.S. provisional application Ser. No. 60/886,214 filed on Jan. 23, 2007. The disclosure of the co-pending provisional application is incorporated herein by reference in its entirety.

### FIELD OF THE DISCLOSURE

Aspects of the present disclosure relate generally to the field of display systems and more particularly to reducing the power consumption of display systems in portable, battery-operated devices such as smartphones and PDAs.

### BACKGROUND

Designers of devices such as laptops, smartphones, PDAs, multimedia players and other battery-operated portable devices frequently need to balance a desire to add power consuming features with a desire to have a long battery life. Device designers can improve batter life by using a larger battery, but this is often undesirable as it increases the overall size and weight of the device. A significant portion of a computing system's power consumption can be traced to the display subsystem, and as a result, increasing the size or resolution of a device's display can greatly lessen a device's battery life.

A display subsystem comprises a display controller as well a display screen. A significant source of the power consumption within the display subsystem can be attributed to the functionality of the display controller. The display controller accesses pixel stores in memory and processes the fetched pixels to render a frame to be displayed on a screen. Modern display systems often require the mixing and blending of multiple display streams to produce a single frame. The typical rate of refresh for LCD devices is on the order of 60 Hz, meaning the display subsystem must generate 60 frames per second.

Although the subsystem is generating 60 frames per second, the actual rate at which the content of the frames changes is typically much lower. Even when showing video or other rapidly changing images, the rate at which frame content changes rarely exceeds 30 Hz. In many usage situations such as email or web browsing, the refresh rate can be significantly lower than 30 Hz, meaning the display subsystem frequently generates one or more duplicates of the same frame.

In order to reduce power consumption, many devices can operate in a low power mode where the operating frequency of the device and the refresh rate of the display can be scaled down. In such a low power mode, however, the operation of the display is coupled to the operational state of the system's processor; such coupling can be undesirable. For example, when making a phone call, the processor needs to operate at a high frequency in order to process the incoming and outgoing audio data, but the screen might only be changing once per second to update a call length timer. Nevertheless, the system will still generate sixty frames per second, even though a significant majority of the frames will be duplicates of previously generated frames.

Given the increasing screen sizes and the high refresh rates of current LCD devices, it is desirable to reduce the power consumption associated with the activity of the display subsystem. Further, it is desirable to do so in a manner that is independent of the operational state of the system's processor.

### SUMMARY

Aspects of the present invention include a display subsystem that can operate in two different display modes—a composition mode and a low power refresh (LPR) mode. In the composition mode, a composition engine can take multiple images from different image streams and combine them into a single display frame formatted for the device's screen. In the LPR mode the display system can store a copy of the display frame produced by the composition engine, and in instances where the display content has not changed, output the stored display frame rather than having the composition engine go through the process of rendering a new frame that would be identical to the previous frame. By entering an LPR mode during periods when display content remains constant, the display system can reduce the amount of data fetched and reduce the amount of processing needed to render a frame, thus reducing bandwidth and power consumption.

A system embodying aspects of the present invention can further include a controller configured to switch between the different display modes upon the detection of a change to a system parameter. The particular mode the display subsystem operates in can be decoupled from the operational state of the processor. Further, the control system can be implemented in hardware, allowing it to avoid the delays associated with software processing, thus achieving a response time sufficiently fast to allow the controller to switch modes on a frame-by-frame basis.

### DESCRIPTION OF THE DRAWINGS

FIG. 1 shows a display system configured to operate in a composition mode.

FIGS. 2a and 2b show display systems configured to operate in both a ion mode and a low power refresh mode.

FIG. 3 shows a flowchart illustrating a method that can be used to switch a composition mode and a low power refresh mode.

### DETAILED DESCRIPTION

Aspects of the present invention include a display subsystem that can operate in two different display modes—a composition mode and a low power refresh (LPR) mode. The system can contain a control system configured to switch between the different modes upon detecting a change to a system parameter. The particular mode the display subsystem operates in can be coupled from the operational state of the processor. Further, the control system can be implemented in hardware, allowing it to avoid the delays associated with software processing, thus achieving a response time sufficiently fast to allow the control system to switch modes on a frame-by-frame basis.

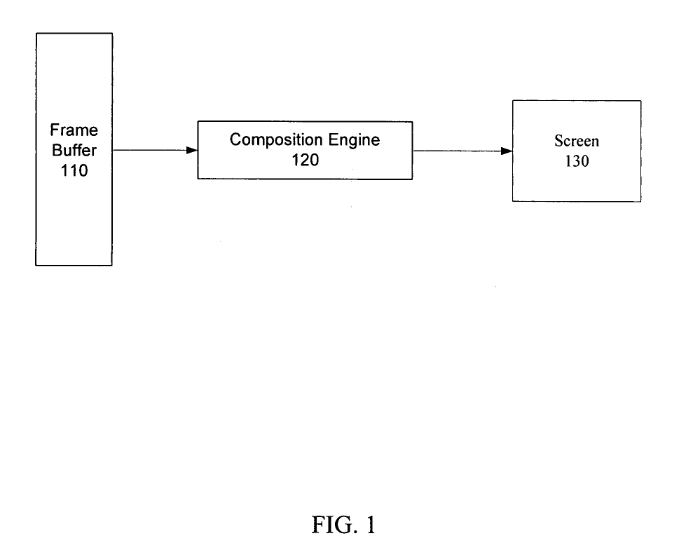

FIG. 1 shows a display subsystem configured to operate in the composition mode. The system includes a frame buffer 110, a composition engine 120, and a screen 130. The frame buffer 110 can be implemented in off-chip memory and can store multiple images from a plurality of image streams. For example, the frame buffer 110 may store a background image, a media overlay such as a picture or video, a battery power indicator overlay, a timer overlay, and a signal strength meter overlay. Each image may be smaller than or equal to the actual size of the screen 130, although it is most common for images to be larger than the screen (i.e. contain more pixels than the screen), thus necessitating that they be downsized. The composition engine 120 can retrieve the images from the frame buffer 110, scale each image to a desired size, layer and blend the images as desired, and render a single frame for transmitting to the screen 130. For a display subsystem refreshing its screen 110 at a rate of 60 Hz and operating in a composition mode, this process of resizing, layering, and rendering will occur 60 times per second regardless of whether the content of the frame changes.

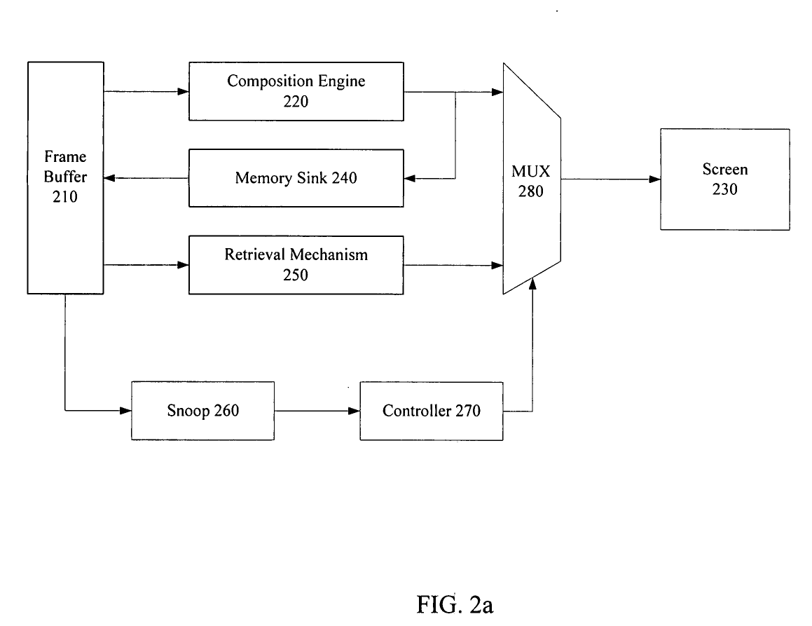

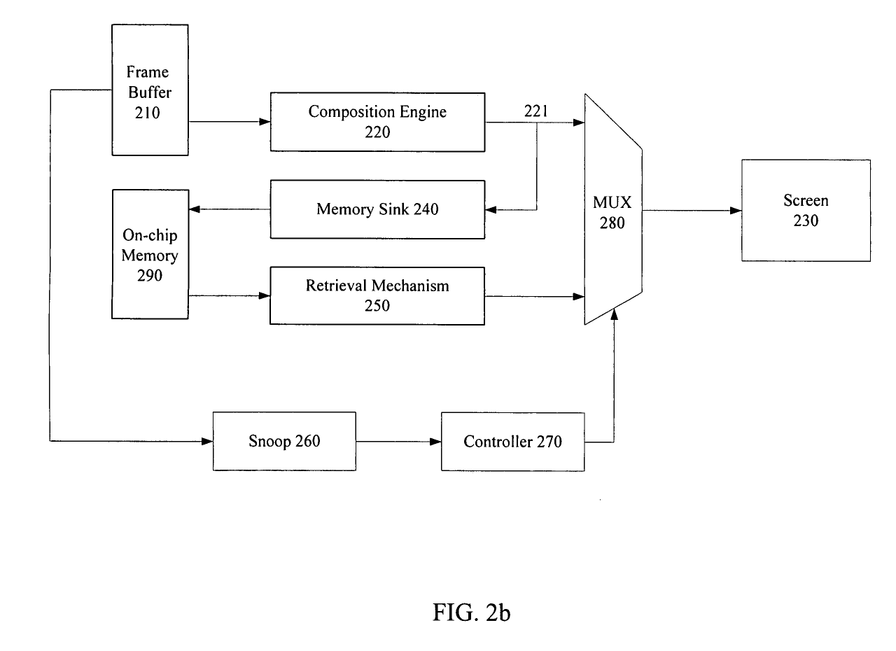

As with the system of FIG. 1, the systems of FIGS. 2a and 2b can operate in a composition mode where a composition engine 220 is capable of taking multiple images from a frame buffer 210 and rendering a single frame to be displayed on a screen 230. The embodiment shown in FIGS. 2a and 2b also contain additional components enabling the systems to operate in an LPR mode. The systems can contain a memory-sink mechanism 240 for capturing a copy of the frame as it appears on the screen 230 and for storing a copy of the captured frame in memory, such as in the frame buffer 210. When the system enters an LPR mode, a retrieval mechanism 250 can retrieve the copy of the captured frame from the frame buffer 210 and transmit the image to the screen 230. Because the captured frame has already been rendered, processes such as scaling, layering, and blending can be avoided, thus reducing power consumption.

In order to save memory and bandwidth, the memory-sink mechanism 240 can optionally include a compression engine to reduce the amount of data needed to store a copy of the frame as well as the amount of data to be retrieved when accessing the frame. The compression engine can use various compression algorithms known in the art to achieve a desired compression ratio. The desired compression ratio can be determined by a system designer based on factors such as an amount of tolerable image degradation and the amount of memory available for storing images.

In order to reduce power consumption and bandwidth, the system can implement a compression scheme sufficient to reduce the amount of data enough to store the compressed image in on-chip memory 290 (as shown in FIG. 2b), thus reducing the number of memory accesses and the associated power consumption.

In systems utilizing a compression engine, the retrieval mechanism 250 can be configured to include a decompression engine for restoring the compressed image to a format suitable for the device's screen 230. Because the compressed image of the frame was already formatted to fit the screen 230 before it was saved to memory, the decompression engine should not have to significantly reconfigure the image before transmitting it to the screen 230, thus reducing the amount of power associated with processing image data. When the system operates in LPR mode, the composition engine 220 can be placed into a low power state by stopping the propagation of clock and power signals through techniques such as clock gating circuitry.

In order to switch between the composition mode and the LPR mode, the system can contain a controller 270 capable of selecting either a first or a second channel on a multiplexor (MUX) 280. Selecting the first channel might mean the composition engine 220 produces the frame supplied to the screen 230 (i.e. the system is in composition mode), while selecting the second channel might mean the retrieval mechanism 250 produces the frame being supplied to the screen 230 (i.e. the system is in LPR mode).

The controller 270 determines which mode to operate in based on a snoop mechanism 260 that monitors a system parameter such as the contents of the frame buffer 210. For example, the snoop mechanism 260 can monitor the frame buffer 210 to detect content changes. The snoop mechanism 260 can detect content changes by looking for changes to memory locations within an address range corresponding to the frame buffer 210.

If the system is operating in a composition mode, then the controller 270 might switch the system into LPR mode if the snoop mechanism 260 does not detect a content change in the frame buffer 210. If the snoop mechanism 260 does detect a change, then the controller 270 might keep the system in composition mode. When operating in LPR mode, the controller 270 can switch the system into composition mode if the snoop mechanism 260 detects a content change but otherwise can keep the system in LPR mode as long as no content changes are detected.

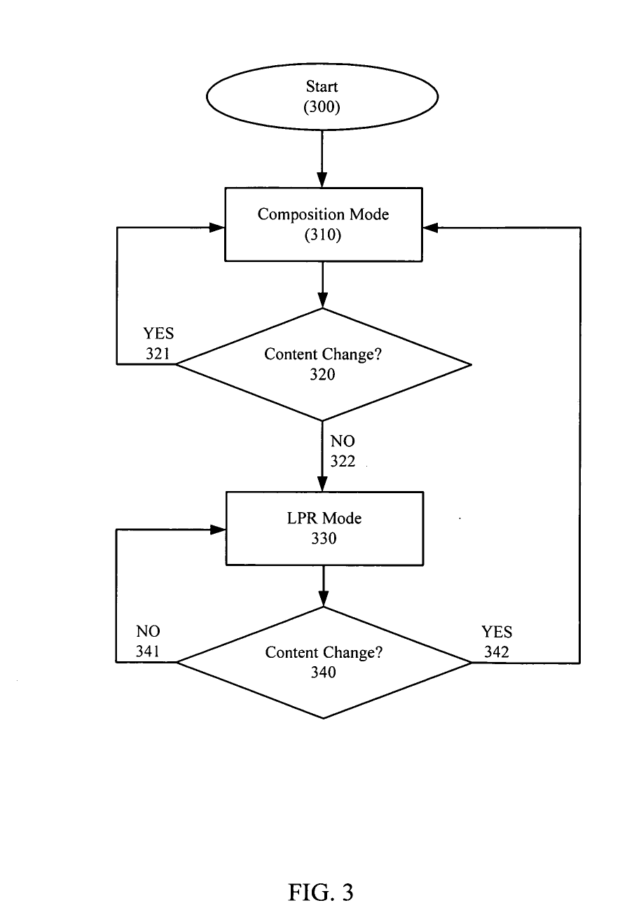

FIG. 3 is a flowchart illustrating a method the controller 270 might use to determine when to switch the operating mode of the display system. The method can start when the system powers up or resets (block 300). The system can then begin outputting images to the screen in the composition mode (block 310). While in the composition mode, a snoop mechanism can monitor a frame buffer for content changes (block 320). If the snoop mechanism detects a content change (path 321), for example, by detecting changes to memory locations within the address range corresponding to the frame buffer, then the display system can stay in composition mode (block 310). If the system does not detect a content change (path 322), then the system can switch to LPR mode (block 330).

In LPR mode (block 330), the snoop mechanism can continue to monitor the frame buffer for content changes (block 340). If the snoop mechanism detects a content change (path 342), then the system will shift from LPR mode back into composition mode (path 342 and block 310). If the snoop mechanism does not detect a content change, then the system can remain in LPR mode (path 341 and block 330). The method can continually repeat itself alternating between the composition mode and the LPR mode while the display is functioning. The system can switch modes as often as between every frame.

Referring back to FIGS. 2a and 2b, another feature of a system embodying aspects of the present invention can include configuring the memory-sink mechanism 240 to implement algorithms to predict when a content change is going to happen. The algorithms, for example, may include monitoring the frequency of content changes, detecting patterns associated with content changes, or identifying that a particular application is running. If the system is running in composition mode and the memory-sink mechanism 240 predicts that the next frame will contain new content, then in order to reduce power consumption, the memory-sink mechanism 240 might not compress and save an image of the next frame output from the composition engine 220. If the memory-sink mechanism 240 predicts incorrectly and the content in the frame buffer 210 does not change, then the system can continue operating in composition mode.

Another feature of a system embodying aspects of the present invention can include using the compressed image stored by the memory-sink mechanism 240 but while still making minor alterations to it. For example, when playing a song on a portable music device the screen 230 might show a picture of an album cover as well as song information and a timer, all overlaid on a background. When the system operates in composition mode, the composition engine 220 has to retrieve the images from the frame buffer 210, resize them, overlay and blend them, and render a single frame in a format suitable for the device's screen 230.

Of the multiple component images that are used to create the displayed frame, it might be that only the image associated with the timer is regularly changing. Therefore, rather than resizing and relayering all the component images, the system can take the copy of the frame saved by the memory-sink mechanism 240, which has already been resized and formatted to the fit the device's screen 230, and only relayer the timer image. Alternatively, the system can be configured to have software overwrite portions of the stored image to make a minor change, such as updating the value of the timer.

The image stored by the memory-sink mechanism 240 can be stored either in a compressed form in the on-chip memory 290 (FIG. 2b) or in an uncompressed form in the frame buffer 210 (FIG. 2a). It is also contemplated that the display system might be configured to only retrieve from memory or to only decompress a portion of the saved image. For example, the system may use all but the last twenty lines of the saved image and combine it with a new bottom twenty lines containing updated timer information. Approaches such as the ones mentioned above, either individually or in combination, can greatly reduce the power and bandwidth consumption of a display controller by reducing the amount of data fetched from memory and reducing the amount of computation needed to render a frame suitably formatted for the device's screen 210.

The foregoing description of embodiments is provided to enable a person skilled in the art to make and use the present invention. Various modifications to these embodiments will be readily apparent to those skilled in the art, and the generic principles and specific examples defined herein may be applied to other embodiments without the use of inventive faculty. For example, some or all of the features of the different embodiments discussed above may be deleted from the embodiment. Therefore, the present invention is not intended to be limited to the embodiments described herein but is to be accorded the widest scope defined only by the claims below and equivalents thereof.

What is claimed is:

1. A display system comprising:
a memory-sink mechanism configured to store a copy of a screen image in memory;
a snoop mechanism configured to monitor a system parameter;
a controller configured to switch said system between first and second modes of operation in response to said snoop mechanism detecting a change to said system parameter;
a retrieval mechanism to retrieve said copy when said system operates in said second mode of operation.

2. The display system of claim 1, wherein said first mode of operation is a composition mode.

3. The display system of claim 1, wherein said second mode of operation is a low-power refresh mode.

4. The display system of claim 1, wherein said memory-sink mechanism is configured to compress said copy.

5. The display system of claim 4, wherein said retrieval mechanism is configured to decompress said copy.

6. The display system of claim 1, wherein said memory is on-chip memory.

7. The display system of claim 1, wherein said system parameter is data stored in a buffer.

8. The display system of claim 1, further comprising:
a composition engine configured to render an image when said system operates in said first mode of operation.

9. The display of claim 8, further comprising:
a multiplexor containing first and second channels for outputting image data, said first channel outputting image data from said composition engine and said second channel outputting image data from said retrieval mechanism.

10. The display system of claim 9, wherein said controller is configured to select a channel on said multiplexor.

11. A method comprising the steps of:
storing a copy of a screen image in memory;
monitoring a system parameter;
switching between first and second modes of operation upon detecting a change to said system parameter;
retrieving said copy in said second mode of operation.

12. The method of claim 11, wherein said first mode of operation is a composition mode.

13. The method of claim 11, wherein said second mode of operation is a low-power refresh mode.

14. The method of claim 11 further comprising:
compressing said copy.

15. The method of claim 14, further comprising:
decompressing said copy.

16. The method of claim 11, wherein said memory is on-chip memory.

17. The method of claim 11, wherein said system parameter is image data.

18. The method of claim 11, wherein switching between said first and said second modes of operation includes selecting a channel on a multiplexor.
